(19) United States
(12) Patent Application Publication
(10) Pub. No.: US 2011/0063297 A1
(43) Pub. Date: Mar. 17, 2011

(54) IMAGE PROCESSING DEVICE, CONTROL METHOD FOR IMAGE PROCESSING DEVICE, AND INFORMATION STORAGE MEDIUM

(75) Inventors: Makoto Toyama, Tokyo (JP); Yoshikatsu Sone, Tokyo (JP); Masashi Endo, Tokyo (JP)

(73) Assignee: KONAMI DIGITAL ENTERTAINMENT CO., LTD., Tokyo (JP)

(21) Appl. No.: 12/881,557

(22) Filed: Sep. 14, 2010

(30) Foreign Application Priority Data
Sep. 16, 2009 (JP) 2009-214945

(51) Int. Cl. G06T 15/50

(52) U.S. Cl. 345/426

(57) ABSTRACT

Provided is a game device for displaying a screen showing a state in which a virtual three-dimensional space having an object placed therein is viewed from a given viewpoint, the game device including: a first image creating unit for creating a first image representing the state in which the virtual three-dimensional space is viewed from the given viewpoint; a coordinate acquiring unit for acquiring three-dimensional coordinates of a light source set in the virtual three-dimensional space; a second image creating unit for creating a second image representing diffusion of light from the light source based on the three-dimensional coordinates of the light source; and a display control unit for displaying a screen obtained by synthesizing the first image and the second image with each other.

### CROSS-REFERENCE TO RELATED APPLICATION

The present application claims priority from Japanese application JP 2009-214945 filed on Sep. 16, 2009, the content of which is hereby incorporated by reference into this application.

### BACKGROUND OF THE INVENTION

1. Field of the Invention

The present invention relates to an image processing device, a control method for an image processing device, and an information storage medium.

2. Description of the Related Art

There is known a game device for displaying a state in which a virtual three-dimensional space having various objects such as game characters and light sources placed therein is viewed from a given viewpoint. For example, there is known a game device in which shadows of objects are rendered under control which is based on positions of light sources and positions and shapes of the objects, to thereby display a game screen (see JP 2007-195747 A).

### SUMMARY OF THE INVENTION

On the game device as described above, light from the light source may not be represented accurately in a case where the light source is positioned outside the range of view corresponding to the game screen, or some other such case. In the case where the light source is positioned outside the range of view, it is impossible to show the state in which light from the light source irradiates a region within the range of view.

The present invention has been made in view of the above-mentioned problem, and it is therefore an object thereof to provide an image processing device, a control method for an image processing device, and an information storage medium, which are capable of showing a state in which light from a light source irradiates a region within a range of view in an appropriate manner, even in a case where the light source is positioned outside the range of view.

In order to solve the above-mentioned problem, according to the present invention, there is provided an image processing device for displaying a screen showing a state in which a virtual three-dimensional space having an object placed therein is viewed from a given viewpoint, the image processing device including: first image creating means for creating a first image representing the state in which the virtual three-dimensional space is viewed from the given viewpoint; coordinate acquiring means for acquiring a three-dimensional coordinate of a light source set in the virtual three-dimensional space; second image creating means for creating a second image representing diffusion of light from the light source based on the three-dimensional coordinate of the light source; and display control means for displaying a screen obtained by synthesizing the first image and the second image.

Further, according to the present invention, there is provided a method of controlling an image processing device for displaying a screen showing a state in which a virtual three-dimensional space having an object placed therein is viewed from a given viewpoint, the method including: creating a first image representing the state in which the virtual three-dimensional space is viewed from the given viewpoint; acquiring a three-dimensional coordinate of a light source set in the virtual three-dimensional space; creating a second image representing diffusion of light from the light source based on the three-dimensional coordinate of the light source; and controlling displaying of a screen obtained by synthesizing the first image and the second image.

Further, according to the present invention, there is provided a program for causing a computer to function as an image processing device for displaying a screen showing a state in which a virtual three-dimensional space having an object placed therein is viewed from a given viewpoint, the program further causing the computer to function as: first image creating means for creating a first image representing the state in which the virtual three-dimensional space is viewed from the given viewpoint; coordinate acquiring means for acquiring a three-dimensional coordinate of a light source set in the virtual three-dimensional space; second image creating means for creating a second image representing diffusion of light from the light source based on the three-dimensional coordinate of the light source; and display control means for displaying a screen obtained by synthesizing the first image and the second image. The computer is a personal computer, a server computer, a home-use game machine, an arcade game machine, a portable game machine, a mobile phone, a personal digital assistant, or the like. Further, an information storage medium according to the present invention is a computer-readable information storage medium having the above-mentioned program recorded thereon.

According to the present invention, it becomes possible to show the state in which the light from the light source irradiates the region within the range of view in an appropriate manner, even in the case where the light source is positioned outside the range of view.

Further, according to an aspect of the present invention, the image processing device further includes depth information acquiring means for acquiring depth information corresponding to each pixel of one of the first image and the second image, and the display control means includes first determination means for determining, in a case where the first image and the second image are subjected to semi-transparent synthesis, a rate of the semi-transparent synthesis for each pixel based on the depth information.

Further, according to another aspect of the present invention, the first image creating means includes shadow image creating means for creating a shadow image representing a shadow of the object, and object image creating means for creating an object image representing a state in which the object is viewed from the given viewpoint. The first image creating means synthesizes the shadow image and the object image to create the first image. The second image creating means sets a pixel value of each pixel of the second image based on whether or not each pixel corresponds to a shadow region of the shadow image.

Further, according to a further aspect of the present invention, the first image creating means includes shadow image creating means for creating a shadow image representing a shadow of the object, and object image creating means for creating an object image representing a state in which the object is viewed from the given viewpoint. The first image creating means synthesizes the shadow image and the object image to create the first image. The display control means includes second determination means for determining, in a case where the first image and the second image are subjected to semi-transparent synthesis, a rate of the semi-transparent synthesis for each pixel of the second image based on whether or not each pixel corresponds to a shadow region of the shadow image.

Further, according to a still further aspect of the present invention, the first image creating means includes shadow image creating means for creating a shadow image representing a shadow of the object, and setting a pixel value of a pixel which is included in a shadow region of the shadow image based on whether or not the pixel corresponds to a light region of the second image, and object image creating means for creating an object image representing a state in which the object is viewed from the given viewpoint. The first image creating means synthesizes the shadow image and the object image to create the first image.

Further, according to a yet further aspect of the present invention, the second image creating means includes coordinate converting means for converting the three-dimensional coordinate of the light source into a two-dimensional coordinate corresponding to the screen, and the second image creating means creates the second image so that the light is diffused from the two-dimensional coordinate of the light source.

Further, according to a yet further aspect of the present invention, the second image creating means includes center point calculating means for calculating a center point of a cross section of a sphere that has the three-dimensional coordinate of the light source set as its center and has a predetermined radius, the cross section being obtained by cutting the sphere along a plane corresponding to the given viewpoint, and coordinate converting means for converting a three-dimensional coordinate of the center point into a two-dimensional coordinate corresponding to the screen. The second image creating means creates the second image so that the light is diffused from the two-dimensional coordinates of the center point.

### BRIEF DESCRIPTION OF THE DRAWINGS

In the accompanying drawings:

FIG. 1 is a diagram illustrating a hardware configuration of a game device according to embodiments of the present invention;

FIG. 2 is a diagram illustrating an example of a virtual three-dimensional space;

FIG. 3 is a diagram illustrating an example of a game screen;

FIG. 4 is a functional block diagram illustrating a group of functions to be implemented on a game device according to a first embodiment of the present invention;

FIG. 5A is a diagram illustrating an example of a first image;

FIG. 5B is a diagram illustrating an example of a second image;

FIG. 5C is a diagram illustrating an example of a composite image;

FIG. 6 is a flow chart illustrating an example of processing to be executed on the game device;

FIG. 7 is a flow chart illustrating an example of processing to be executed on a game device according to a second embodiment of the present invention;

FIG. 8A is a diagram illustrating an Xw-Zw plane of the virtual three-dimensional space;

FIG. 8B is a diagram illustrating an Xw-Yw plane of the virtual three-dimensional space;

FIG. 9 is a functional block diagram illustrating a group of functions to be implemented on a game device according to a third embodiment of the present invention;

FIG. 10 is a diagram illustrating an example of depth information;

FIG. 11 is a flow chart illustrating an example of processing to be executed on the game device according to the third embodiment of the present invention;

FIG. 12 is a flow chart illustrating an example of processing to be executed on a game device according to a fourth embodiment of the present invention;

FIG. 13A is a diagram illustrating an example of an object image;

FIG. 13B is a diagram illustrating an example of a shadow image;

FIG. 13C is a diagram illustrating another example of the second image;

FIG. 14 is a flow chart illustrating an example of processing to be executed on a game device according to a fifth embodiment of the present invention; and

FIG. 15 is a flow chart illustrating an example of processing to be executed on a game device according to a sixth embodiment of the present invention.

### DETAILED DESCRIPTION OF THE INVENTION

### 1. First Embodiment

Hereinafter, a detailed description is given of an example of embodiments of the present invention with reference to the drawings. The description is given herein of a case where the present invention is applied to a game device, which is an embodiment of an image processing device. The game device according to the embodiments of the present invention is implemented by, for example, a home-use game machine (stationary game machine), a portable game machine, a mobile phone, a personal digital assistant (PDA), or a personal computer. The description is given herein of a case where the game device according to a first embodiment of the present invention is implemented by a home-use game machine.

### 1-1. Hardware Configuration of Game Device

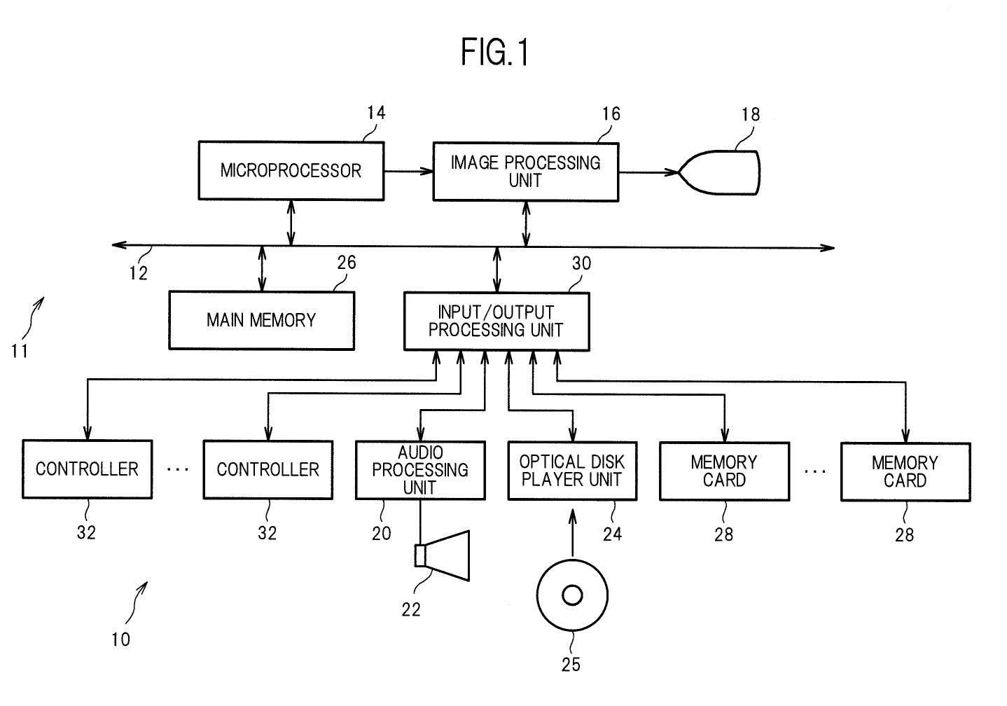

FIG. 1 is a diagram illustrating a configuration of the game device according to the embodiments of the present invention. As illustrated in FIG. 1, on a game device 10, an optical disk 25 and a memory card 28, which are information storage media, are inserted into a home-use game machine 11. Further, a display unit 18 and an audio outputting unit 22 are connected to the game device 10. For example, a home-use television set is used as the display unit 18, and an internal speaker thereof is used as the audio outputting unit 22.

The home-use game machine 11 is a known computer game system including a bus 12, a microprocessor 14, an image processing unit 16, an audio processing unit 20, an optical disk player unit 24, a main memory 26, an input/output processing unit 30, and a controller 32. The components except the controller 32 are accommodated in a casing.

The bus 12 is used for exchanging an address and data among the components of the home-use game machine 11. The microprocessor 14, the image processing unit 16, the main memory 26, and the input/output processing unit 30 are interconnected via the bus 12 so as to allow data communications between them.

The microprocessor 14 controls the components of the home-use game machine 11 based on an operating system stored in a ROM (not shown), a program read from the optical disk 25, and data read from the memory card 28.

The main memory 26 includes, for example, a RAM, and the program read from the optical disk 25 and the data read from the memory card 28 are written to the main memory 26 as necessary. The main memory 26 is also used as a work memory for the microprocessor 14.

The image processing unit 16 includes a VRAM. The image processing unit 16 renders a game screen in the VRAM based on image data sent from the microprocessor 14. The image processing unit 16 converts this content into a video signal and outputs the video signal to the display unit 18 at a predetermined timing.

The input/output processing unit 30 is an interface used for the microprocessor 14 to access the audio processing unit 20, the optical disk player unit 24, the memory card 28, and the controller 32. The audio processing unit 20, the optical disk player unit 24, the memory card 28, and the controller 32 are connected to the input/output processing unit 30.

The audio processing unit 20 includes a sound buffer. The audio processing unit 20 outputs various kinds of audio data such as game music, game sound effects, and voice messages that are read from the optical disk 25 and stored in the sound buffer from the audio outputting unit 22.

The optical disk player unit 24 reads a program recorded on the optical disk 25 according to an instruction from the microprocessor 14. It should be noted that although the optical disk 25 is used herein for supplying a program to the home-use game machine 11, any other information storage media such as a CD-ROM and a ROM card may also be used. Alternatively, the program may also be supplied to the home-use game machine 11 from a remote site via a data communication network such as the Internet.

The memory card 28 includes a nonvolatile memory (for example, EEPROM). The home-use game machine 11 includes a plurality of memory card slots for insertion of the memory cards 28 so that a plurality of the memory cards 28 may be simultaneously inserted. The memory card 28 is detachable from the memory card slot, and is used, for example, for storing various kinds of game data such as save data.

The controller 32 is used for a player to input various game operations. The input/output processing unit 30 scans states of portions of the controller 32 at fixed intervals (for example, every 1/60^{th} of a second). Operation signals representing results of the scanning are input to the microprocessor 14 via the bus 12.

The microprocessor 14 judges a game operation performed by the player based on the operation signals sent from the controller 32. The home-use game machine 11 may be connected to a plurality of the controllers 32. In other words, in the home-use game machine 11, the microprocessor 14 controls a game based on the operation signals input from each of the controllers 32.

### 1-2. Virtual Three-Dimensional Space of Game Device

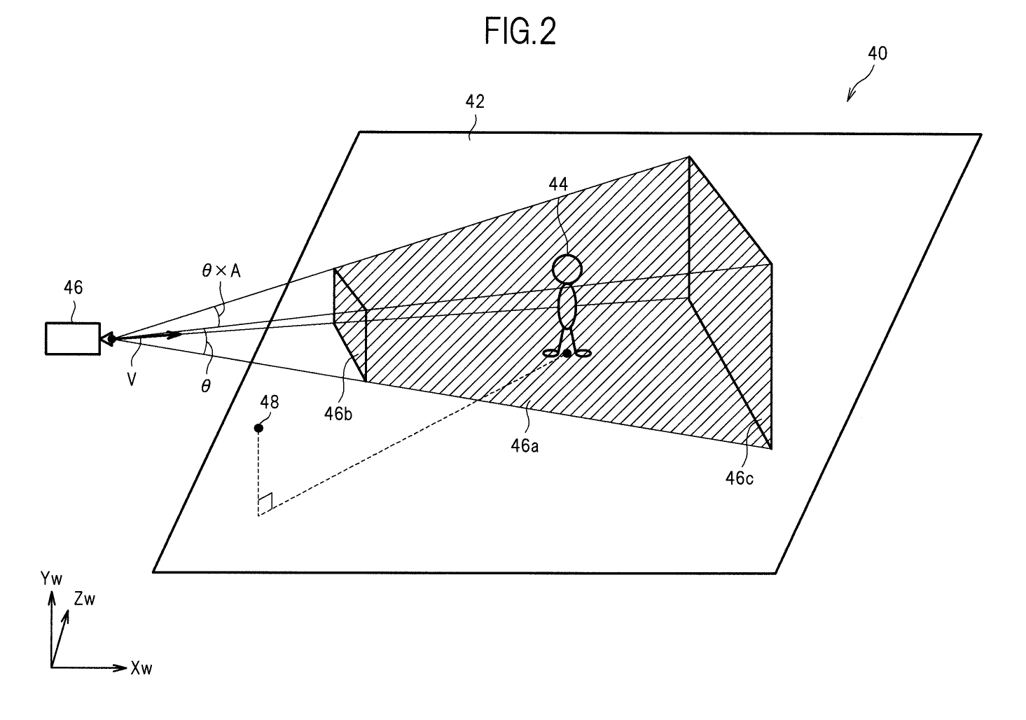

On the game device 10, a virtual three-dimensional space (virtual three-dimensional game space) is built in the main memory 26. FIG. 2 is a diagram illustrating a part of the virtual three-dimensional space (virtual three-dimensional space 40) built in the main memory 26. As illustrated in FIG. 2, the virtual three-dimensional space 40 has an Xw axis, a Yw axis, and a Zw axis set therein, which are orthogonal to one another. A position in the virtual three-dimensional space 40 is specified by a three-dimensional coordinate of those coordinate axes, that is, a world coordinate value (coordinate value of a world coordinate system).

A field object 42 representing a ground or a floor is placed in the virtual three-dimensional space 40. The field object 42 is placed parallel to, for example, an Xw-Zw plane. A character object 44 is placed on the field object 42.

It should be noted that if a soccer game is executed on the game device 10, for example, objects representing soccer goals and an object representing a soccer ball, which are omitted in FIG. 2, are placed. In other words, a soccer stadium is formed in the virtual three-dimensional space 40.

In addition, a virtual camera 46 (viewpoint) is set in the virtual three-dimensional space 40. A game screen showing a state in which the virtual three-dimensional space 40 is viewed from the virtual camera 46 is generated, and is displayed on the display unit 18.

Objects included in a viewing frustum 46a corresponding to the virtual camera 46 are displayed in the game screen. As illustrated in FIG. 2, the viewing frustum 46a is a hatched region of a field of view of the virtual camera 46, which is sandwiched between a near clip 46b and a far clip 46c.

As illustrated in FIG. 2, the field of view of the virtual camera 46 is determined based on a coordinate indicating the position of the virtual camera 46, a viewing vector v indicating a viewing direction of the virtual camera 46, an angle of view 8 of the virtual camera 46, and an aspect ratio A of the game screen. Those values are stored in the main memory 26, and are changed appropriately depending on the game situation.

The near clip 46b defines, among regions displayed in the game screen, a region closest to the virtual camera 46 in the virtual three-dimensional space 40. The far clip 46c defines, among the regions displayed in the game screen, a region farthest from the virtual camera 46 in the virtual three-dimensional space 40.

Information on a distance between the near clip 46b and the virtual camera 46, and information on a distance between the far clip 46c and the virtual camera 46 are stored in the main memory 26. Those pieces of information on the distances are changed appropriately depending on the game situation. In other words, the viewing frustum 46a is a region obtained by cutting the field of view of the virtual camera 46 along the near clip 46b and the far clip 46c.

As illustrated in FIG. 2, a light source 48 is set in the virtual three-dimensional space 40. Performing processing described later based on a coordinate indicating the position of the light source 48 enables representation of a state in which light is diffused in the game screen. Alternatively, a shadow may be cast by the character object 44 on the field object 42 with the light from the light source 48.

### 1-3. Two-Dimensional Coordinate Corresponding to Game Screen

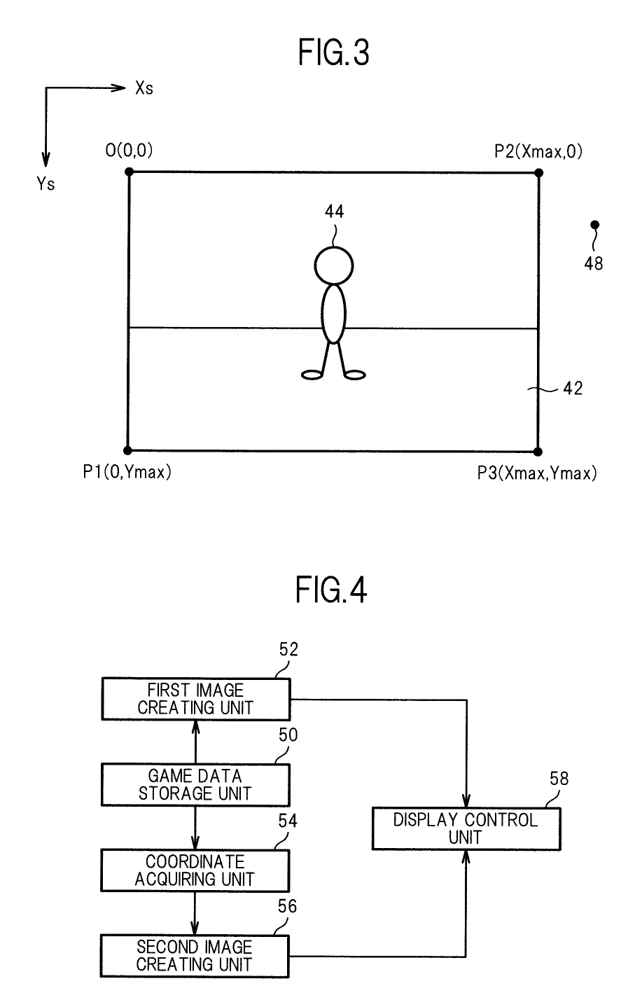

FIG. 3 illustrates a game screen showing a state in which the virtual three-dimensional space illustrated in FIG. 2 is viewed from the virtual camera 46. Displaying of the game screen is updated every constant cycle (for example, every 1/60^{th} of a second). As illustrated in FIG. 3, the field object 42 and the character object 44 which are included in the viewing frustum 46a are displayed in the game screen. The game screen has an Xs axis and a Ys axis set therein, which are orthogonal to each other. For example, it is assumed that an upper left corner is set as an origin O (0,0), and coordinates corresponding to each pixel are assigned.

It is similarly assumed that a lower left corner of the game screen is set as a coordinate P1 (0,Ymax); an upper right corner thereof, a coordinate P2 (Xmax, 0); and a lower right corner thereof, a coordinate P3 (Xmax,Ymax). In other words, in the example of the game screen illustrated in FIG. 3, the ratio between Xmax and Ymax, which constitute the region of the game screen, corresponds to the aspect ratio A of the game screen.

When the game screen is displayed, the microprocessor 14 first performs predetermined arithmetic processing using a matrix with respect to a three-dimensional coordinate of each object within the region defined by the viewing frustum 46a. Through this arithmetic processing, the three-dimensional coordinate of each object is converted into a screen coordinate (coordinates of the screen coordinate system), that is, a two-dimensional coordinate. The two-dimensional coordinate specifies the display position of the object in the game screen.

In the example illustrated in FIG. 2, the light source 48 is positioned outside the region defined by the viewing frustum 46a, and hence, as illustrated in FIG. 3, the two-dimensional coordinate corresponding to the light source 48 is positioned outside the region of the game screen. In the processing described later, an image representing diffusion of light from the light source 48 is created based on the two-dimensional coordinate of the light source 48.

### 1-4. Functions to be Implemented on Game Device

FIG. 4 is a functional block diagram illustrating a group of functions to be implemented on the game device 10. As illustrated in FIG. 4, a game data storage unit 50, a first image creating unit 52, a coordinate acquiring unit 54, a second image creating unit 56, and a display control unit 58 are implemented on the game device 10. Those functions are implemented by the microprocessor 14 operating based on programs read from the optical disk 25.

### [1-4-1. Game Data Storage Unit]

The game data storage unit 50 is implemented mainly by the main memory 26 and the optical disk 25. The game data storage unit 50 stores various kinds of data necessary for the game. In the case of this embodiment, the game data storage unit 50 stores game situation data indicating a current situation of the virtual three-dimensional space, and the like.

The virtual three-dimensional space illustrated in FIG. 2 is built in the main memory 26 based on the game situation data. Information on three-dimensional coordinates of each object, the virtual camera 46, and the light source 48, and information on hue, saturation, and value (HSV) of the game screen, such as colors of the object and intensity of light from the light source, are stored as the game situation data. Further the information on the distance between the near clip 46b and the virtual camera 46, and the information on the distance between the far clip 46c and the virtual camera 46 are stored as the game situation data. Still further, the viewing vector v and the angle of view 0 of the virtual camera 46 and the aspect ratio A of the game screen are stored as the game situation data.

### [1-4-2. First Image Creating Unit]

The first image creating unit 52 is implemented mainly by the microprocessor 14. The first image creating unit 52 creates a first image representing a state in which the virtual three-dimensional space 40 is viewed from the virtual camera 46. The first image is created by referring to the game data storage unit 50. In other words, the first image is an image directly representing colors of each object without consideration of diffusion of light from the light source 48.

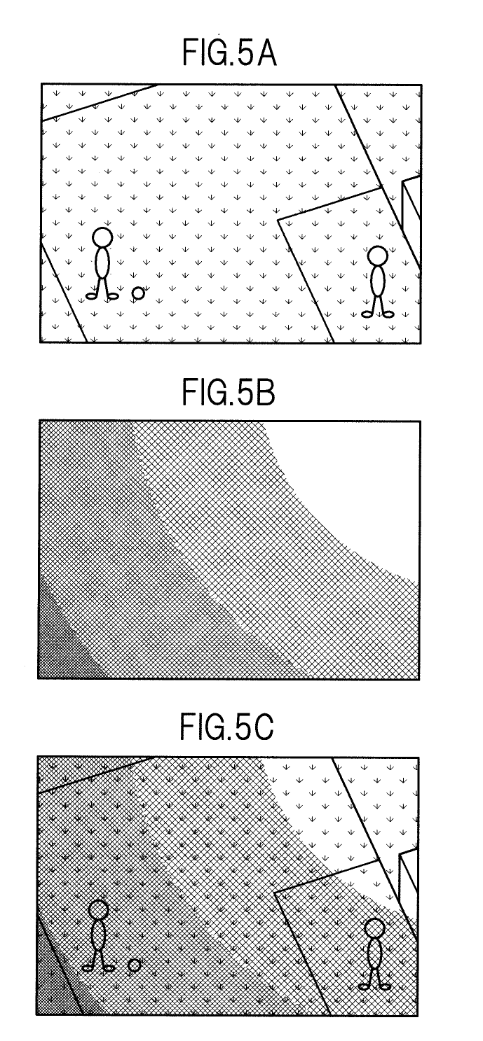

FIG. 5A is a diagram illustrating an example of the first image created by the first image creating unit 52. The first image represents the state in which the virtual three-dimensional space 40 is viewed from the virtual camera 46, and as illustrated in FIG. 5A, the first image is created with the colors of each object represented directly.

### [1-4-3. Coordinate Acquiring Unit]

The coordinate acquiring unit 54 is implemented mainly by the microprocessor 14. The coordinate acquiring unit 54 acquires a three-dimensional coordinate of the light source 48 stored in the game data storage unit 50.

### [1-4-4. Second Image Creating Unit]

The second image creating unit 56 is implemented mainly by the microprocessor 14. The second image creating unit 56 creates a second image representing diffusion of light from the light source 48 based on the three-dimensional coordinate of the light source 48 acquired by the coordinate acquiring unit 54. The second image is an image representing only a gradation of light but no object within the viewing frustum 46a.

FIG. 5B is a diagram illustrating an example of the second image created by the second image creating unit 56. FIG. 5B exemplifies a second image created in a case where a two-dimensional coordinate of the light source 48 indicates the position illustrated in FIG. 3. As illustrated in FIG. 5B, a second image in which light is diffused so as to draw a circle whose center is the two-dimensional coordinate of the light source 48 is created.

### [1-4-5. Display Control Unit]

The display control unit 58 is implemented mainly by the microprocessor 14 and the image processing unit 16. The display control unit 58 displays, on the display unit 18, a game screen obtained by synthesizing the first image created by the first image creating unit 52 and the second image created by the second image creating unit 56.

As a method of synthesizing the first image and the second image with each other, semi-transparent synthesis that uses a so-called alpha value (semi-transparent synthesis rate or opacity) is employed. For example, if the alpha value is set to a real value ranging from 0 to 1, a certain pixel in the game screen (assuming that a coordinate thereof is set as (Xs,Ys)) has its pixel value calculated as “(1−(alpha value))×(pixel value of the coordinate (Xs,Ys) of first image)+(alpha value)×(pixel value of the coordinate (Xs,Ys) of second image)”. For example, the alpha value is set to 0.2. It should be noted that the method of synthesizing the first image and the second image with each other is not limited to the method described above and any other method may be applied.

FIG. 50 is a diagram illustrating an example of an image displayed by the display control unit 58. As illustrated in FIG. 5C, an image obtained by synthesizing the first image and the second image with each other is displayed, to thereby display a game screen showing a state in which light from the light source positioned outside the range of view irradiates the region within the range of view.

### 1-5. Processing to be Executed on Game Device

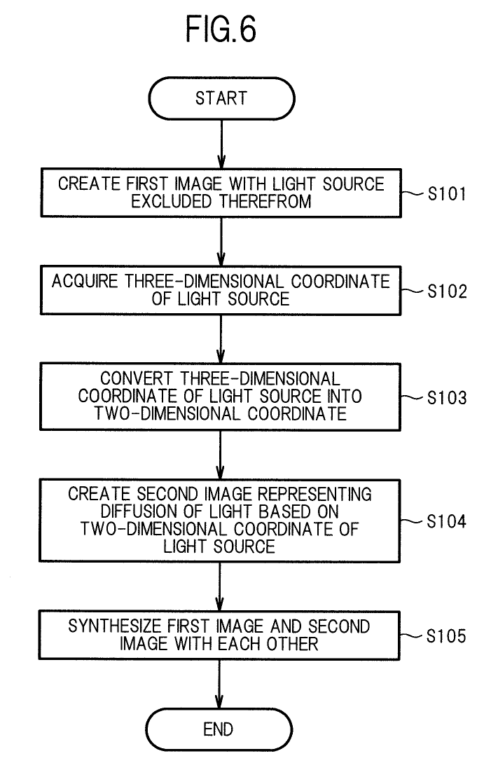

FIG. 6 is a flow chart illustrating an example of processing to be executed on the game device 10 in every constant cycle (for example, every 1/60 seconds). The processing of FIG. 6 is executed by the microprocessor 14 operating based on a program read from the optical disk 25.

As illustrated in FIG. 6, the microprocessor 14 (first image creating unit 52) first refers to the game data storage unit 50 to create a first image with the light source 48 excluded therefrom (S101). The first image created in S101 is an image in which colors of each object included in the viewing frustum 46a are represented directly.

It should be noted that although the first image with the light source 48 excluded therefrom is created in S101, the method of creating the first image is not limited thereto as long as colors of each object included in the viewing frustum 46a are represented directly. For example, in S101, the first image may be created so as to represent the shadow of each object included in the viewing frustum 46a or the like.

Subsequently, the microprocessor 14 (coordinate acquiring unit 54) refers to the game situation data stored in the main memory 26 to acquire the three-dimensional coordinate of the light source 48 (S102). The microprocessor 14 (second image creating unit 56 as coordinate converting means) converts the three-dimensional coordinate of the light source 48 into a two-dimensional coordinate corresponding to the game screen (S103). In S103, predetermined arithmetic processing using a matrix is performed as described above for the conversion processing.

The microprocessor 14 creates a second image representing diffusion of light from the light source 48 based on the two-dimensional coordinate of the light source 48 (S104). In S104, the second image is created so that light may be diffused from the light source 48 positioned at the above-mentioned two-dimensional coordinate. For example, if the two-dimensional coordinate of the light source 48 indicates the position illustrated in FIG. 3, the second image is created by calculating a circle that has this position set as its center and has a predetermined radius, and by determining each pixel value so as to diffuse light having its intensity set depending on the distance between the center point of the circle and the pixel within the game screen. In other words, each pixel value is determined so that if the distance between the center point of the circle and the pixel is short, light may be strong, and if the distance therebetween is long, light may be weak.

It should be noted that the second image may be created by determining each pixel value so that light may be diffused based not on the above-mentioned circle but on another shape (ellipse or quadrangle) instead. In this case, similarly to the above, each pixel value is determined so as to diffuse light having its intensity set depending on the distance between the two-dimensional coordinate of the light source 48 and the pixel, and as a result, the second image is created.

Further, in S104, the method of creating the second image is not limited to the methods described above as long as the second image is created based on the two-dimensional coordinate of the light source 48. For example, the second image may be created by assigning the two-dimensional coordinate of the light source 48 to a predetermined equation that represents diffusion of light, to calculate the pixel value of each pixel.

Subsequently, the microprocessor 14 (display control unit 58) synthesizes the first image created in S101 and the second image created in S104 with each other, and displays the composite image on the display unit 18 (S105). In S105, the first image and the second image are subjected to semi-transparent synthesis based on a predetermined alpha value, and the composite image is displayed on the display unit 18. The alpha value may vary depending on the game situation data or the like. For example, the alpha value is set so that the rate for the second image may be set smaller in a case of rain in the game screen or in a case of sunset in the game screen.

### 1-6. Summary of First Embodiment

The game device 10 according to the first embodiment described above displays the game screen obtained by synthesizing the first image representing the virtual three-dimensional space (each object) and the second image representing diffusion of light from the light source 48 with each other. With the game device 10 according to the first embodiment, it is possible to display the game screen showing a state in which light irradiates the region of the game screen even if the light source 48 is positioned outside the region of the game screen.

Further, the game device 10 creates the second image by converting the three-dimensional coordinate of the light source 48 into the two-dimensional coordinate. The conversion processing can be implemented through relatively simple processing based on the positional relationship between the light source 48 and each object, or the like. Processing load can be reduced compared with, for example, a method of converting colors of the object for each pixel.

It should be noted that the present invention is not limited to the embodiment described above, and appropriate modifications may be made thereto without departing from the gist of the present invention. For example, this embodiment has been described by taking the home-use game machine as an example, but the game machine may be an arcade game machine installed at a video game arcade or the like.

In S103, the second image is created based on the two-dimensional coordinate of the light source 48 that is obtained by converting the three-dimensional coordinate of the light source 48. Instead of this conversion processing, the three-dimensional coordinate of the light source 48 may be used for creating the second image. For example, in a case where the viewing vector v, which indicates the direction of the virtual camera 46, matches with the Xw axis direction, or in another such case, a Yw coordinate component and a Zw coordinate component of the three-dimensional coordinate of the light source 48 may be used for creating the second image. As a further method, a positional relationship between the center point of the near clip 46b and the light source 48 in terms of the three-dimensional coordinate may be used for creating the second image.

The description has been given of the case where the three-dimensional coordinate of the light source 48 is the world coordinate value. Alternatively, the three-dimensional coordinate of the light source 48 that are used for creating the second image may be a view coordinate value having the position of the virtual camera 46 set as its origin, or other such coordinate value.

The first embodiment has been described with regard to the case of one light source 48, but an arbitrary number of the light sources 48 may be placed in the virtual three-dimensional space 40. For example, if the game device 10 executes a soccer game in which a soccer match is held at night, a plurality of the light sources 48 may be placed at positions corresponding to the lights of an actual soccer stadium. If the second image is created, an image in which light is diffused from each of the light sources 48 is created. In other words, processing similar to that of S104 is performed on each of the light sources 48, and as a result, diffusion of light is calculated. Each diffusion of light is added for each pixel, to thereby create the second image.

### 2. Second Embodiment

A second embodiment is described below. In the first embodiment, the second image is created by converting the three-dimensional coordinate of the light source 48 into the two-dimensional coordinate. In this regard, the second embodiment has a feature in that the second image is created based on a center point of a cross section of a sphere that has the three-dimensional coordinate of the light source 48 and has a predetermined radius, the cross section being obtained by cutting the sphere along the near clip 46b.

It should be noted that a hardware configuration and a functional block diagram of a game device 10 according to the second embodiment are the same as in the first embodiment (see FIGS. 1 and 4), and hence the description thereof is omitted herein. Further, in the game device 10 according to the second embodiment, a game is executed by generating a virtual three-dimensional space similar to that of FIG. 2.

### 2-1. Processing to be Executed on Game Device

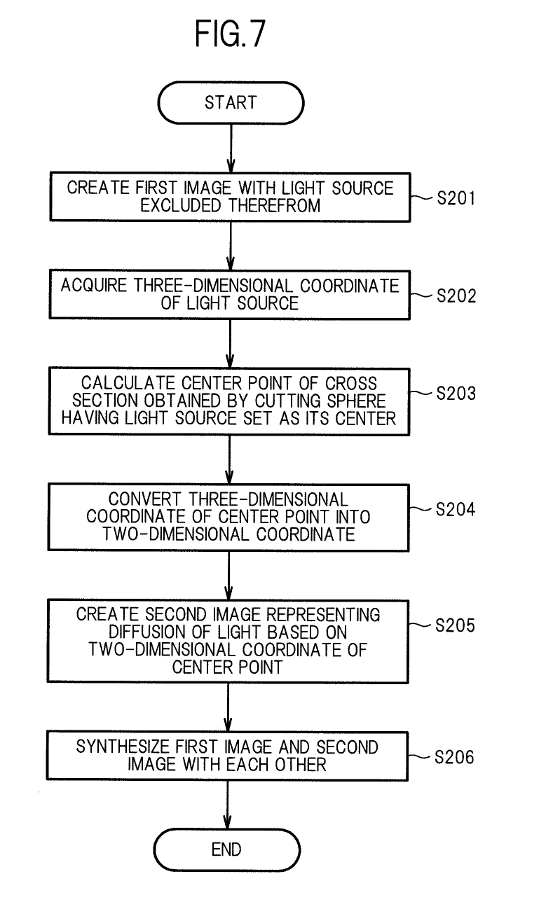

Processing illustrated in FIG. 7 corresponds to the processing of the first embodiment, which is illustrated in FIG. 6. In other words, the processing illustrated in FIG. 7 is executed on the game device 10 every constant cycle (for example, every 1/60^{th} of a second).

As illustrated in FIG. 7, S201 and S202 are the same as S101 and S102, respectively, and hence the description thereof is omitted.

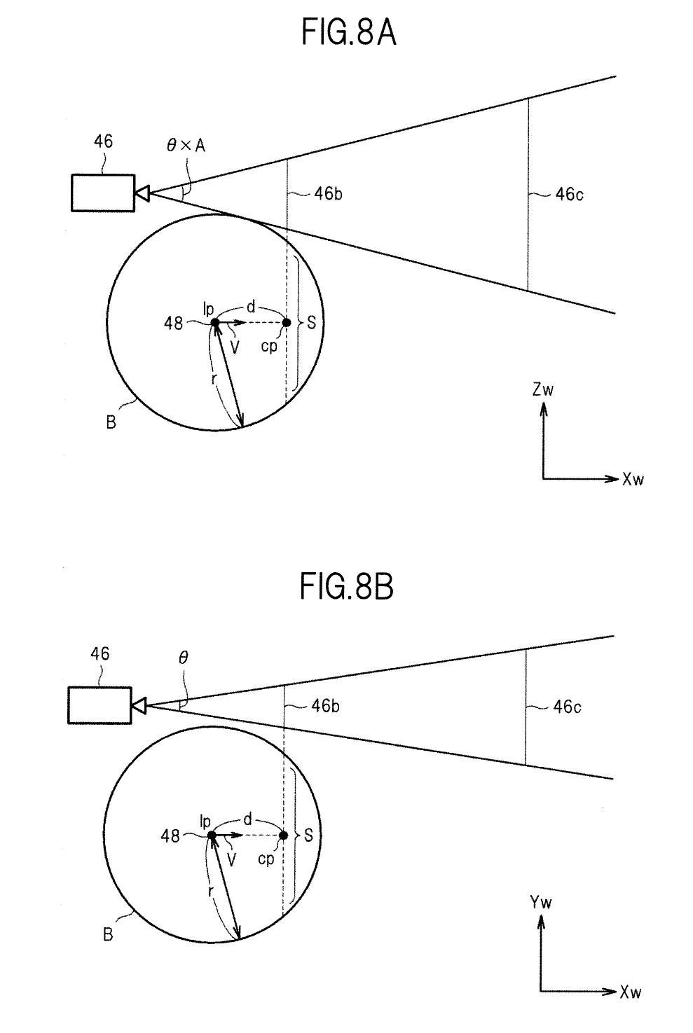

The microprocessor 14 (second image creating unit 56 as center point calculating means) calculates a center point (point cp of FIGS. 8A and 8B) of a cross section (surface S of FIGS. 8A and 8B) of a sphere that has the three-dimensional coordinate of the light source 48 set as its center and has a predetermined radius r (sphere B of FIGS. 8A and 8B), the cross section being obtained by cutting the sphere B along the near clip 46b (S203). The predetermined radius r corresponds to a distance at which light from the light source 48 arrives. Information indicating the radius of the sphere is stored in the optical disk 25 or the like.

Specifically, in S203, after the information indicating the radius of the sphere is read from the optical disk 25 or the like, the microprocessor 14 determines the cross section of the sphere based on the position of the near clip 46b, and calculates the center point thereof. It should be noted that the information indicating the radius of the sphere may vary depending on the game situation data or the like. For example, in a soccer game in which a soccer match is held under foggy conditions, the radius of the sphere may be set smaller.

More specifically, as illustrated in FIG. 8A, for example, the three-dimensional coordinate of the center point cp is calculated as a point that is positioned apart from the three-dimensional coordinate lp of the light source 48 in a direction indicated by a unit vector v of the virtual camera 46 by a distance d from the light source 48 to the near clip 46b. The distance d is calculated based on the three-dimensional coordinate of the virtual camera 46, the three-dimensional coordinate lp of the light source, and the distance between the virtual camera 46 and the near clip 46b. FIG. 8A is a diagram illustrating an Xw-Zw plane of the virtual three-dimensional space 40, and FIG. 8B is a diagram illustrating an Xw-Yw plane of the virtual three-dimensional space 40.

It should be noted that although the cross section is obtained by cutting the above-mentioned sphere along the near clip 46b in the example of S203, the method of cutting the sphere is not limited thereto as long as the sphere is cut along a plane corresponding to the game screen. For example, the sphere may be cut along the far clip 46c or along a plane passing through the object included in the viewing frustum 46a. In S203, the center point of the cross section as described above only needs to be calculated.

The microprocessor 14 (second image creating unit 56 as coordinate converting means) converts the three-dimensional coordinate of the center point that is calculated in S203 into the two-dimensional coordinate (S204). Similarly to S103, conversion processing using a matrix is performed in S204.

The microprocessor 14 creates a second image representing diffusion of light from the light source 48 based on the two-dimensional coordinate of the center point (S205). In S205, processing similar to that of S104 is performed. In S104, the reference point to be used when diffusion of light is represented corresponds to the two-dimensional coordinate of the light source 48, but in S205, the reference point to be used when diffusion of light is represented corresponds to the two-dimensional coordinate of the center point of the cross section, which is the only difference between S205 and S104. In other words, the second image is created so that light may be diffused from the center point of the cross section.

Subsequently, the microprocessor 14 (display control unit 58) synthesizes the first image created in S201 and the second image created in S205 with each other, and displays the composite image on the display unit 18 (S206).

### 2-2. Summary of Second Embodiment

The game device 10 according to the second embodiment described above displays the game screen obtained by synthesizing the first image representing the virtual three-dimensional space 40 (each object) and the second image representing diffusion of light from the center point of the cross section of the sphere having the light source 48 as its center. With the game device 10 according to the second embodiment, similarly to the first embodiment, it is possible to display the game screen showing a state in which light irradiates the region of the game screen through relatively simple processing.

It should be noted that on the game device 10, any one of the processing of the first embodiment, which is illustrated in FIG. 6, and the processing of the second embodiment, which is illustrated in FIG. 7, may be used, depending on the game situation. For example, if the virtual camera 46 has a range of view set at a predetermined angle, the processing of the second embodiment, which is illustrated in FIG. 7, may be executed to create the game screen, and if the virtual camera 46 has a range of view set at other angles, the processing of the first embodiment, which is illustrated in FIG. 6, may be executed to create the game screen.

As described above, by using any one type of processing depending on the game situation, it is possible to reproduce the image representing actual diffusion of light with higher accuracy, and to perform optimal processing that suits the situation. For example, if a large number of objects are placed in the virtual three-dimensional space 40, the processing of the first embodiment, which is simpler and is illustrated in FIG. 6, is executed, to thereby reduce processing load to be imposed due to the displaying of the game screen.

### 3. Third Embodiment

A third embodiment is described below. In the first and second embodiments, the first image representing a state in which the virtual three-dimensional space 40 is viewed from the virtual camera 46, and the second image representing diffusion of light from the light source 48, are synthesized with each other.

However, simply synthesizing the first image and the second image with each other may result in a lack of representation of light shielding. For example, if an object is positioned between the virtual camera 46 and the light source 48, light is supposed to be shielded by the object. The region in which light is shielded is expected to be darkened, but simply synthesizing the first image and the second image with each other may cause the region that is expected to be darkened to be lightened due to the second image representing diffusion of light.

In order to prevent the above-mentioned phenomenon, there is conceived a technique of synthesizing images with each other with the rate for the second image representing diffusion of light set as 0 in a region that is expected to be darkened in a case where light is shielded. However, this technique may cause an object to become unnaturally dark. In other words, if light from the light source 48 is shielded by an object, it is impossible to show a state in which light travels around the object.

In this regard, the third embodiment has a feature in that depth information is taken into consideration when the first image and the second image are synthesized with each other.

It should be noted that a hardware configuration of a game device 10 according to the third embodiment is the same as in the first embodiment (see FIG. 1), and hence the description thereof is omitted herein. Further, in the game device 10 according to the third embodiment, a game is executed by generating a virtual three-dimensional space 40 similar to that of FIG. 2.

A functional block diagram of the game device 10 according to the third embodiment is different from that of the first embodiment in that a depth information acquiring unit 60 is further provided.

### 3-1. Functions to be Implemented on Game Device

FIG. 9 is a functional block diagram illustrating a group of functions to be implemented on the game device 10 according to the third embodiment. As illustrated in FIG. 9, the depth information acquiring unit 60 is further provided in the third embodiment. This function is implemented by the microprocessor 14 operating based on a program read from the optical disk 25.

### [Depth Information Acquiring Unit]

The depth information acquiring unit 60 acquires depth information corresponding to each pixel in the game screen displayed on the display unit 18. The depth information refers to information indicating a distance from the virtual camera 46. For example, depth information corresponding to pixels in which the character object 44 is displayed indicates a distance between the virtual camera 46 and the character object 44.

The depth information is generated by using a programmable shader or the like stored in the ROM (not shown) or the like. For example, the depth information is represented as an 8-bit grayscale image, and is stored in the main memory 26 or the like. It is assumed that the pixel value of a pixel closest to the virtual camera 46 is set as 255 (which represents white), and the pixel value of a pixel farthest from the virtual camera 46 is set as 0 (which represents black). In other words, the pixel value is expressed by a value ranging from 0 to 255 depending on the distance from the virtual camera 46. It should be noted that the method of generating the depth information is not limited to the method described above, and various known methods may be applied thereto.

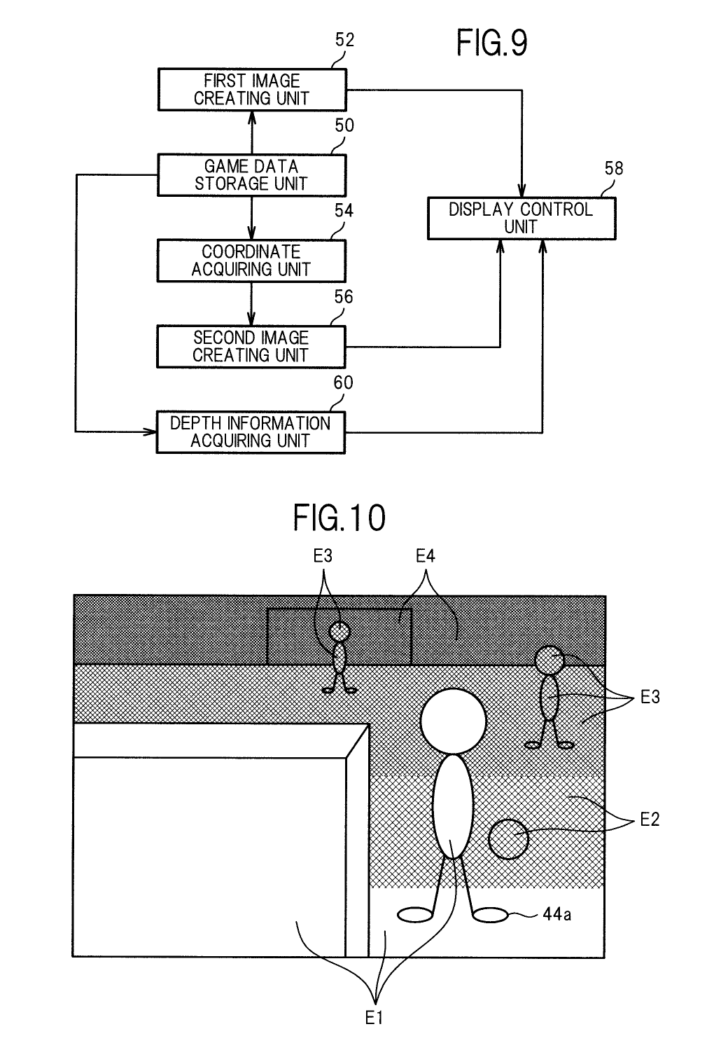

FIG. 10 is a diagram illustrating an example of the depth information. FIG. 10 exemplifies depth information generated if a soccer game is executed on the game device 10, and in the soccer game, the virtual camera 46 is placed behind a character object 44a serving as a goalkeeper at the time of a so-called goal kick. In this example, the depth information is virtually set in four levels (region E1 to region E4 of FIG. 10).

As illustrated in FIG. 10, the region E1 in which pixels closer to the virtual camera 46 are arranged is represented to be whiter (non-shaded region), and the region E4 in which pixels farther from the virtual camera 46 are arranged is represented to be blacker (shaded region). Tones of the regions E2 and E3 between the region E1 and the region E4 are determined depending on the distance from the virtual camera 46. In other words, the distance from the virtual camera 46 is represented based on the pixel value.

### 3-2. Processing to be Executed on Game Device

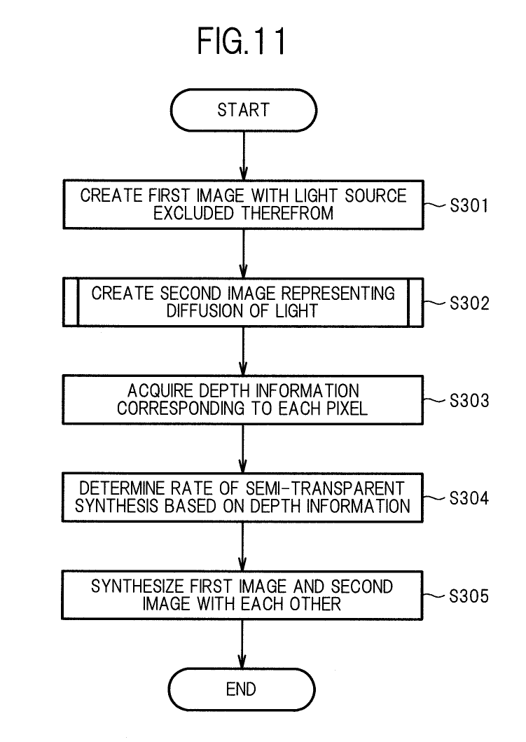

Processing illustrated in FIG. 11 corresponds to the processing of the first embodiment, which is illustrated in FIG. 6. In other words, the processing illustrated in FIG. 11 is executed on the game device 10 every constant cycle (for example, every 1/60^{th} of a second).

As illustrated in FIG. 11, S301 is the same as S101 and hence the description thereof is omitted.

The microprocessor 14 creates a second image representing diffusion of light from the light source 48 (S302). In S302, the processing of from S102 to S104 or the processing of from S202 to S205 is performed, for example, to thereby create the second image.

Subsequently, the microprocessor 14 (depth information acquiring unit 60) acquires depth information corresponding to each pixel in the game screen (S303). As described above, the depth information is generated by using, for example, the programmable shader each time frame processing is executed on the display unit 18, and is stored in the main memory 26 or the like.

The microprocessor 14 (display control unit 58 as first determination means) determines a rate of semi-transparent synthesis for each pixel based on the depth information (S304). In S304, the rate of semi-transparent synthesis is determined based on the pixel value illustrated in FIG. 10. The determined rate is stored in the main memory 26 in association with the position of the pixel.

For example, if the pixel value of a certain pixel in the game screen is calculated as “(1−(alpha value))×(pixel value of first image)+(alpha value)×(pixel value of second image)” to synthesize images with each other, in S304, the calculation is made so as to satisfy the following equation:

(alpha value)=α(for example,0.3)−Δα(Δα=0/2*((pixel value)/255)).

By defining the alpha value as described above, it is possible to determine the alpha value corresponding to the depth information for each pixel. In this case, as the pixel becomes closer to the virtual camera 46, the alpha value becomes smaller, and hence the rate for the second image can be set smaller.

It should be noted that the method of determining the rate of semi-transparent synthesis in S304 is not limited to the method described above as long as the rate is determined based on the depth information. For example, a data table in which the depth information and the rate of semi-transparent synthesis are associated with each other may be prepared, or the rate of semi-transparent synthesis may be calculated based on a predetermined equation.

The microprocessor 14 synthesizes the first image and the second image with each other based on the rate of semi-transparent synthesis determined in S304, and displays the composite image on the display unit 18 (S305).

### 3-3. Summary of Third Embodiment

The game device 10 according to the third embodiment described above acquires the depth information corresponding to each pixel in the game screen, and determines the rate of semi-transparent synthesis for each pixel based on the depth information. With the game device 10 according to the third embodiment, even if light from the light source 48 is shielded, the light that travels around the shielding object can be represented. The rate of semi-transparent synthesis is determined for each pixel, and hence it is possible to prevent the region displayed in the game screen, in which the shielding object is positioned, from being blackened excessively. In other words, it is possible to show a state in which, even though light from the light source 48 is shielded by an object, the light travels around the object.

### 4. Fourth Embodiment

A fourth embodiment is described below. In the first to third embodiments, the game screen is created so as to show diffusion of light from the light source 48.

However, simply synthesizing the first image and the second image with each other may result in an obscure shadow of an object represented in the first image due to the second image representing diffusion of light.

In this regard, the fourth embodiment has a feature in that diffusion of light is represented while a shadow of each object in the virtual three-dimensional space 40 is reflected to the game screen.

It should be noted that a hardware configuration and a functional block diagram of a game device 10 according to the fourth embodiment are the same as in the first embodiment (see FIGS. 1 and 4), and hence description thereof is omitted herein. Further, in the game device 10 according to the fourth embodiment, a game is executed by generating a virtual three-dimensional space similar to that of FIG. 2.

### 4-1. Processing to be Executed on Game Device

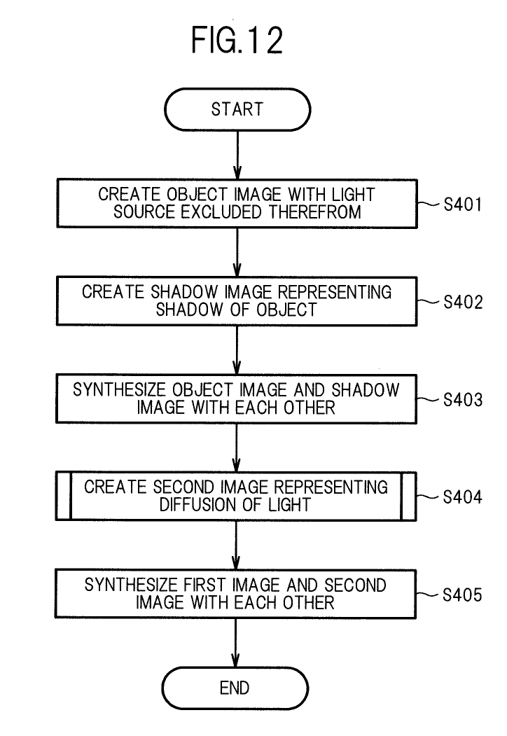

Processing illustrated in FIG. 12 corresponds to the processing of the first embodiment, which is illustrated in FIG. 6. In other words, the processing illustrated in FIG. 12 is executed on the game device 10 every constant cycle (for example, every 1/60^{th} of a second).

As illustrated in FIG. 12, the microprocessor 14 (first image creating unit 52 as object image creating means) first creates an image representing the virtual three-dimensional space (each object) with the light source excluded therefrom (S401). In S101 (FIG. 6), the shadow of each object included in the viewing frustum 46a may be included in the first image, but in S401, the shadow is not included therein and only an image of each object is created, which is the difference between S401 and S101. The image created in S401 is hereinafter referred to as an object image. The object image is stored in the main memory 26 or the like.

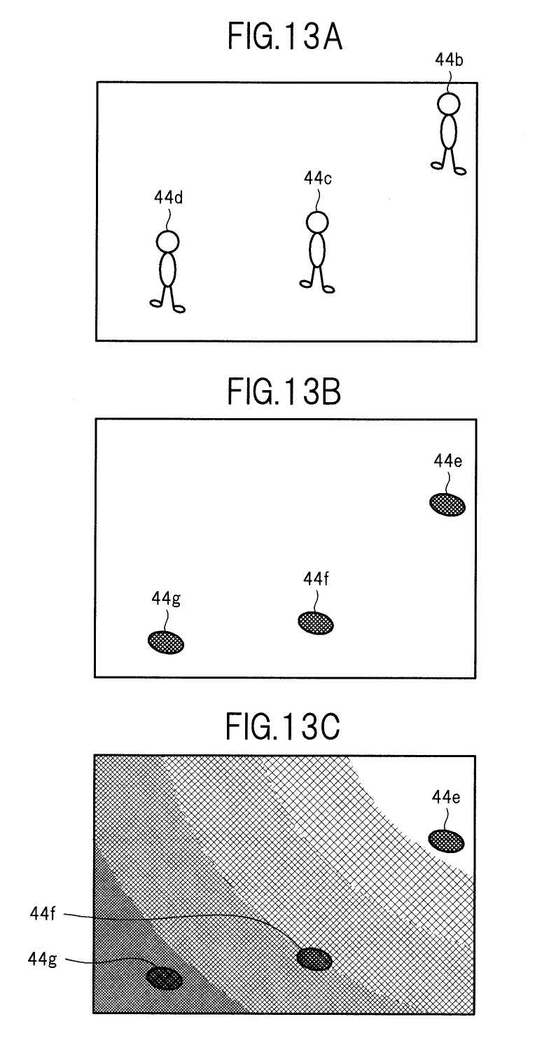

FIG. 13A illustrates an example of the object image created in S401. As illustrated in FIG. 13A, created is an image representing a state in which each of character objects 44b, 44c, and 44d are viewed from the virtual camera 46 with the light source excluded therefrom.

The microprocessor 14 (first image creating unit 52 as shadow image creating means) creates an image representing a shadow of each object included in the viewing frustum 46a (S402). In S402, the microprocessor 14 creates the image by filling in a predetermined region corresponding to coordinates indicating the position of the objects stored in the game data storage unit 50, or calculating a shadow region of the shadow image based on an equation predetermined so that the shadow may be cast on the field object 42 through irradiation of light to each object from the light source 48. The image created in S402 is hereinafter referred to as shadow image. The shadow image is stored in the main memory 26 or the like.

FIG. 13B illustrates an example of the shadow image created in S402. As illustrated in FIG. 13B, created is an image in which shadows 44e, 44f, and 44g are placed at positions corresponding to those of the character objects 44b, 44c, and 44d illustrated in FIG. 13A, respectively. The shadows included in the shadow image may have different color tones. For example, a shadow closer to the light source 48 may be thicker, and a shadow farther from the light source 48 may be thinner.

Subsequently, the microprocessor 14 synthesizes the object image created in S401 and the shadow image created in S402 with each other to create a first image (S403). The semi-transparent synthesis similar to that of S105 is performed as the synthesizing processing of S403.

The microprocessor 14 creates a second image representing diffusion of light based on the shadow image created in S402 (S404). In S404, processing similar to the processing of from S102 to S104 illustrated in FIG. 6 or the processing of from S202 to S205 illustrated in FIG. 7 is performed. In S404, the pixel value of each pixel in the second image is set based on whether or not the pixel corresponds to the shadow region of the shadow image, which is the difference between S404 and S102 to S104, or S202 to S205. More specifically, the pixel value of a pixel in the second image which corresponds to the shadow region of the shadow image is decreased (that is, so that light may become weaker) compared with a case where the pixel does not correspond to the shadow region of the shadow image, which is the difference between S404 and S102 to S104, or S202 to S205.

FIG. 13C illustrates an example of the second image created in S404. As illustrated in FIG. 13C, the second image is created so that the regions corresponding to the shadows 44e, 44f, and 44g of the shadow image illustrated in FIG. 13B may be darkened compared with the case of no shadow. In S404, an image representing diffusion of light is created through processing similar to, for example, processing of from S102 to S104, and pixels in the image which correspond to the shadow regions of the shadow image are darkened by a predetermined value. For example, those pixels are each set to have ⅔ the pixel value of those in the case of no shadow.

It should be noted that in S404, the method of creating the second image is not limited to the method described above as long as the second image is created based on the shadow regions of the shadow image. As another method, the rates of darkness setting may be made different between the pixel close to the light source 48 and the pixel far from the light source 48, among the shadow regions of the shadow image.

S405 is the same as S105, and hence a description thereof is omitted.

### 4-2. Summary of Fourth Embodiment

The game device 10 according to the fourth embodiment described above synthesizes the shadow image and the object image with each other to create the first image, and sets pixel values of pixels in the second image (image representing diffusion of light from the light source 48) which correspond to the shadow regions of the shadow image so that light may become weaker (that is, so that the regions may be darkened). With the game device 10 according to the fourth embodiment, the thickness of the shadow corresponding to each object can be represented with high accuracy. In other words, it is possible to prevent the shadows of objects represented in the first image from becoming lighter and thus unnoticeable when the first image and the second image are synthesized with each other.

### 5. Fifth Embodiment

A fifth embodiment is described below. In the fourth embodiment, the second image is created so that the shadow regions of the shadow image may be darkened. In this regard, the fifth embodiment has a feature in that the rate of semi-transparent synthesis is determined for each pixel based on a shadow region included in the shadow image before the first image and the second image are synthesized with each other.

It should be noted that a hardware configuration and a functional block diagram of a game device 10 according to the fifth embodiment are the same as in the first embodiment (see FIGS. 1 and 4), and hence the description thereof is omitted herein. Further, in the game device 10 according to the fifth embodiment, a game is executed by generating a virtual three-dimensional space similar to that of FIG. 2.

### 5-1. Processing to be Executed on Game Device

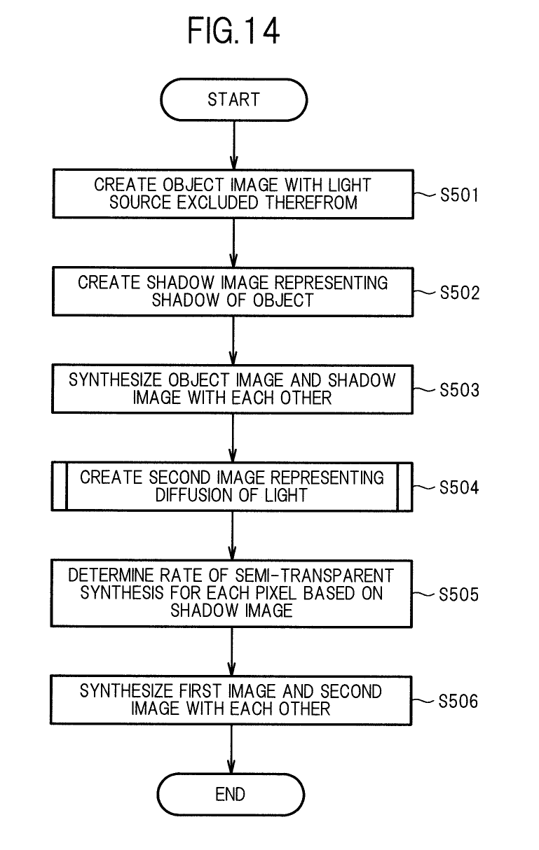

Processing illustrated in FIG. 14 corresponds to the processing of the first embodiment, which is illustrated in FIG. 6. In other words, the processing illustrated in FIG. 14 is executed on the game device 10 every constant cycle (for example, every 1/60^{th} of a second).

As illustrated in FIG. 14, S501 to S503 are the same as S401 to S403, respectively, and hence a description thereof is omitted.

The microprocessor 14 creates a second image representing diffusion of light (S504). In S504, the processing of from S102 to S104 or the processing of from S202 to S205 is performed, to thereby create the second image.

The microprocessor 14 (display control unit 58 as second determination means) determines a rate of semi-transparent synthesis for each pixel based on the shadow image created in S502 (S505). In S505, the rate of semi-transparent synthesis is determined for each pixel in the second image based on whether or not the pixel corresponds to the shadow region of the shadow image. Specifically, for the pixel in the second image which corresponds to the shadow region of the shadow image, the rate of semi-transparent synthesis is set smaller than that for the pixel outside the region.

For example, if the pixel value of a certain pixel in the game screen is calculated as “(1−(alpha value))×(pixel value of first image)+(alpha value)×(pixel value of second image)” to synthesize images with each other, in S505, the rate of semi-transparent synthesis is determined as described below. That is, the alpha value of a pixel corresponding to the shadow region of the shadow image is set to 0.4, and the alpha value of a pixel corresponding to other regions is set to 0.5. In this case, for the pixel corresponding to the shadow region of the shadow image, the rate of semi-transparent synthesis for the second image (image representing diffusion of light from the light source) is smaller, and hence, at the time of semi-transparent synthesis to be performed in S506 described later, the first image and the second image are synthesized with each other so that the shadow region of the shadow image may not be too obscure.

It should be noted that the method of determining the rate of semi-transparent synthesis in S505 is not limited to the method described above as long as the rate is determined based on the shadow image. For example, a data table in which the pixel value of the shadow image and the rate of semi-transparent synthesis are associated with each other may be prepared so as to be referred to in S505.

The microprocessor 14 synthesizes the first image and the second image with each other based on the rate determined in S505 (S506).

### 5-2. Summary of Fifth Embodiment

The game device 10 according to the fifth embodiment described above synthesizes the shadow image and the object image with each other to create the first image, and sets the rate of semi-transparent synthesis for the pixel in the second image which corresponds to the shadow region of the shadow image smaller than that for the pixel which does not correspond to the shadow region. With the game device 10 according to the fifth embodiment, the thickness of the shadow corresponding to each object can be represented with high accuracy. In other words, it is possible to prevent the shadows of objects represented in the first image from becoming obscure when the first image and the second image are subjected to the semi-transparent synthesis.

### 6. Sixth Embodiment

A sixth embodiment is described below. In the fourth embodiment, the second image is created so that the shadow regions of the shadow image may be darkened. In the fifth embodiment, the rate of semi-transparent synthesis is determined for each pixel based on the shadow region included in the shadow image before the first image and the second image are synthesized with each other. In this regard, the sixth embodiment has a feature in that a shadow image is created so that a shadow of the shadow image which is represented in a region of the second image which corresponds to a light region light may become thicker.

It should be noted that a hardware configuration and a functional block diagram of a game device 10 according to the sixth embodiment are the same as in the first embodiment (see FIGS. 1 and 4), and hence the description thereof is omitted herein. Further, in the game device 10 according to the sixth embodiment, a game is executed by generating a virtual three-dimensional space similar to that of FIG. 2.

### 6-1. Processing to be Executed on Game Device

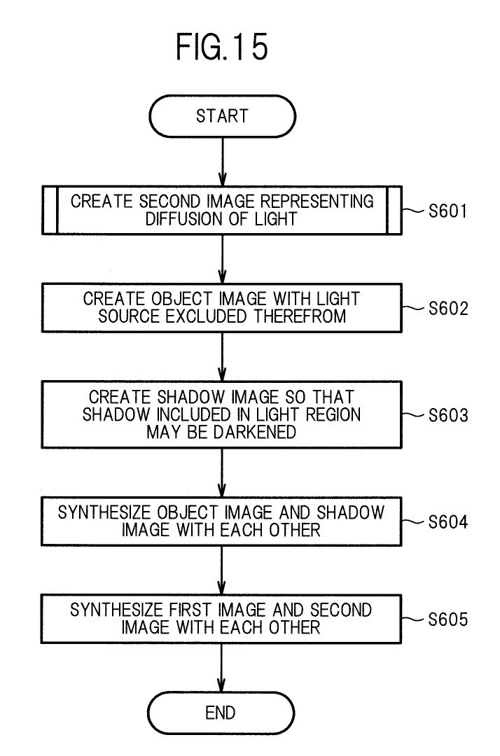

Processing illustrated in FIG. 15 corresponds to the processing of the first embodiment, which is illustrated in FIG. 6. In other words, the processing illustrated in FIG. 15 is executed on the game device 10 every constant cycle (for example, every 1/60^{th} of a second).

As illustrated in FIG. 15, S601 and S602 are the same as S504 and S501, respectively, and hence the description thereof is omitted.

The microprocessor 14 (first image creating unit 52 as shadow image creating means) creates a shadow image representing shadows of objects (S603). In this case, the pixel value of a pixel in the shadow image which is included in the shadow region is set based on whether or not the pixel corresponds to the light region of the second image.

Specifically, it is judged by referring to the pixel value of the second image that a pixel having brightness higher than a predetermined value corresponds to the light region, and if a pixel in the shadow image which is included in a region in which the shadow is represented corresponds to the light region of the second image, the pixel is darkened (so that the shadow may be darkened) compared with a case where the pixel does not correspond to the light region of the second image. It should be noted that in S603, the method of creating the shadow image is not limited to the method described above as long as the shadow image is created based on the light region of the second image. For example, a shadow having a distance from the light source 48 falling within a range of a fixed value may be darkened.

The microprocessor 14 synthesizes the object image created in S602 and the shadow image created in S603 with each other to create a first image (S604). Processing similar to that of S503 is performed in S604.

S605 is the same as S105, and hence the description thereof is omitted.

### 6-2. Summary of Sixth Embodiment

If a pixel which is included in a region in which the shadow is represented corresponds to the light region of the second image when the shadow image is created, the game device 10 according to the sixth embodiment described above sets the pixel value of the pixel so that the shadow may be darkened. With the game device 10 according to the sixth embodiment, the thickness of the shadow corresponding to each object can be represented with high accuracy. In other words, it is possible to prevent the shadows of objects represented in the first image from becoming obscure when the first image (shadow image) and the second image are subjected to the semi-transparent synthesis.

It should be noted that the first to sixth embodiments have been described by exemplifying the image processing device applied to the game device, but the image processing device according to the present invention is also applicable to other devices such as a personal computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image processing device for displaying a screen showing a state in which a virtual three-dimensional space having an object placed therein is viewed from a given viewpoint, the image processing device comprising:
first image creating means for creating a first image representing the state in which the virtual three-dimensional space is viewed from the given viewpoint;
coordinate acquiring means for acquiring a three-dimensional coordinate of a light source set in the virtual three-dimensional space;
second image creating means for creating a second image representing diffusion of light from the light source based on the three-dimensional coordinate of the light source; and
display control means for displaying a screen obtained by synthesizing the first image and the second image.

2. The image processing device according to claim 1, further comprising depth information acquiring means for acquiring depth information corresponding to each pixel of one of the first image and the second image,
wherein the display control means comprises first determination means for determining, in a case where the first image and the second image are subjected to semi-transparent synthesis, a rate of the semi-transparent synthesis for each pixel based on the depth information.

3. The image processing device according to claim 1, wherein:
the first image creating means comprises:
shadow image creating means for creating a shadow image representing a shadow of the object; and
object image creating means for creating an object image representing a state in which the object is viewed from the given viewpoint;
the first image creating means synthesizes the shadow image and the object image to create the first image; and
the second image creating means sets a pixel value of each pixel of the second image based on whether or not each pixel corresponds to a shadow region of the shadow image.

4. The image processing device according to claim 1, wherein:
the first image creating means comprises:
shadow image creating means for creating a shadow image representing a shadow of the object; and
object image creating means for creating an object image representing a state in which the object is viewed from the given viewpoint;
the first image creating means synthesizes the shadow image and the object image to create the first image; and
the display control means comprises second determination means for determining, in a case where the first image and the second image are subjected to semi-transparent synthesis, a rate of the semi-transparent synthesis for each pixel of the second image based on whether or not each pixel corresponds to a shadow region of the shadow image.

5. The image processing device according to claim 1, wherein:
the first image creating means comprises:
shadow image creating means for creating a shadow image representing a shadow of the object, and setting a pixel value of a pixel of the shadow image which is included in a shadow region of the shadow image based on whether or not the pixel corresponds to a light region of the second image; and
object image creating means for creating an object image representing a state in which the object is viewed from the given viewpoint; and
the first image creating means synthesizes the shadow image and the object image to create the first image.

6. The image processing device according to claim 1, wherein:
the second image creating means comprises coordinate converting means for converting the three-dimensional coordinate of the light source into a two-dimensional coordinate corresponding to the screen; and
the second image creating means creates the second image so that the light is diffused from the two-dimensional coordinate of the light source.

7. The image processing device according to claim 1, wherein:
the second image creating means comprises:
center point calculating means for calculating a center point of a cross section of a sphere that has the three-dimensional coordinate of the light source set as its center and has a predetermined radius, the cross section being obtained by cutting the sphere along a plane corresponding to the given viewpoint; and
coordinate converting means for converting a three-dimensional coordinate of the center point into a two-dimensional coordinate corresponding to the screen; and
the second image creating means creates the second image so that the light is diffused from the two-dimensional coordinate of the center point.

8. A control method for an image processing device for displaying a screen showing a state in which a virtual three-dimensional space having an object placed therein is viewed from a given viewpoint, the method comprising:
creating a first image representing the state in which the virtual three-dimensional space is viewed from the given viewpoint;
acquiring a three-dimensional coordinate of a light source set in the virtual three-dimensional space;
creating a second image representing diffusion of light from the light source based on the three-dimensional coordinate of the light source; and
controlling displaying of a screen obtained by synthesizing the first image and the second image.

9. A computer-readable information storage medium having a program recorded thereon, the program causing a computer to function as an image processing device for displaying a screen showing a state in which a virtual three-dimensional space having an object placed therein is viewed from a given viewpoint,
the program further causing the computer to function as:
first image creating means for creating a first image representing the state in which the virtual three-dimensional space is viewed from the given viewpoint;
coordinate acquiring means for acquiring a three-dimensional coordinate of a light source set in the virtual three-dimensional space;
second image creating means for creating a second image representing diffusion of light from the light source based on the three-dimensional coordinate of the light source; and
display control means for displaying a screen obtained by synthesizing the first image and the second image.
